(19) United States
(12) Patent Application Publication
(10) Pub. No.: US 2023/0053893 A1
(43) Pub. Date: Feb. 23, 2023

(54) HEAD TRACKER ASSEMBLY

(71) Applicants: JENNIFER HENDRIX, WAXAHACHIE, TX (US); TYLER WILLIAM HARRIST, FORT WORTH, TX (US); KEVIN TUNG, MANSFIELD, TX (US)

(72) Inventors: JENNIFER HENDRIX, WAXAHACHIE, TX (US); TYLER WILLIAM HARRIST, FORT WORTH, TX (US); KEVIN TUNG, MANSFIELD, TX (US)

(21) Appl. No.: 17/893,045

(22) Filed: Aug. 22, 2022

Related U.S. Application Data
(60) Provisional application No. 63/235,621, filed on Aug. 20, 2021.

(51) Int. Cl. G06F 3/01; G06F 3/0346

(52) U.S. Cl. CPC G06F 3/012; G06F 3/0346

(57) ABSTRACT

A method of orienting an IMU to an object includes determining a physical offset between the IMU and the object. The user mounts the IMU on the object of interest in a position that is not necessarily physically aligned with the object of interest. The user places the object of interest into a known reference orientation and triggers the system via an input device to capture the IMU's momentary orientation. The assembly calculates the offset between the captured IMU orientation and the reference orientation of the object. The assembly continuously applies the calculated offset to the raw IMU orientation to calculate the orientation of the object of interest.

### CROSS REFERENCE TO RELATED APPLICATIONS

This application claims the benefit of an earlier filing date and right of priority to U.S. Provisional Application No. 63/235,621, filed 20 Aug. 2021, the contents of which is incorporated by reference herein in its entirety.

### BACKGROUND OF THE INVENTION

### 1. Field of the Invention

The present application relates to a tracking unit, and more particularly to a unit with an IMU device with built-in alignment capability.

### 2. Description of Related Art

An inertial measurement unit (IMU) is an electronic device that measures and reports a body's specific force, angular rate, and sometimes the orientation of the body, using a combination of accelerometers, gyroscopes, and sometimes magnetometers. The “body” can refer to any object such as aerial vehicles, human movements, satellites, and so forth. Some IMUs consist of only the sensor array and only seem to output raw data. In other configurations, some IMUs are integrated with a processor to allow the sensor fusion algorithms to be done on-board. This configuration can be useful. Other capabilities such as Bluetooth transmitters, batteries, encasement, charging ports are also possible. These can be modified with particular focuses in mind which also leads to the variations discussed above.

An IMU has a defined front, back, top, bottom, left, and right side. Therefore, an issue that can commonly arise is proper orientation. A user often cares about the proper or precise orientation within some sort of body or device. However, there are generally very limited ways to mount an IMU onto a body or device to ensure that the front of the IMU is aligned with the front of the body or device.

Usually, an IMU is mounted physically to an object of interest with the purpose of measuring the motion and/or orientation of that object. An IMU, however, is really only capable of measuring the motion and/or orientation of itself. Therefore, either the IMU must be mounted “in line” with the object that it is meant to measure, or the physical offset between the IMU and the object of interest must be known. For permanently mounted IMUs (i.e. on an aircraft), this offset is easily knowable, but for IMUs that are NOT mounted permanently, this offset is not readily knowable. For instance, if an IMU is meant to be a wearable sensor intended to measure the orientation of a user's head, the offset may be different every time the user dons the wearable sensor. (i.e. the user could mount it in a different orientation each time the device is used).

Although great strides have been made with respect to IMUs, considerable shortcomings remain. An IMU with a built-in capability to measure (or assess) the offset between itself and the object of interest (i.e. the object to which it is mounted), and the ability to perform calculations which apply said offset to its own movement/orientation so that it can report the movement/orientation of the object of interest is needed.

### BRIEF SUMMARY OF THE INVENTION

It is an object of the present application to provide an IMU capable of measuring an offset between itself and an object of interest it is mounted to. Additionally, the IMU being configured to calculate the movement/orientation of the object based off the offset of the IMU.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a top view of an IMU assembly according to an embodiment of the present application.

FIG. 2 is a perspective view of an IMU in the IMU assembly of FIG. 1 illustrating 6 degrees of freedom.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

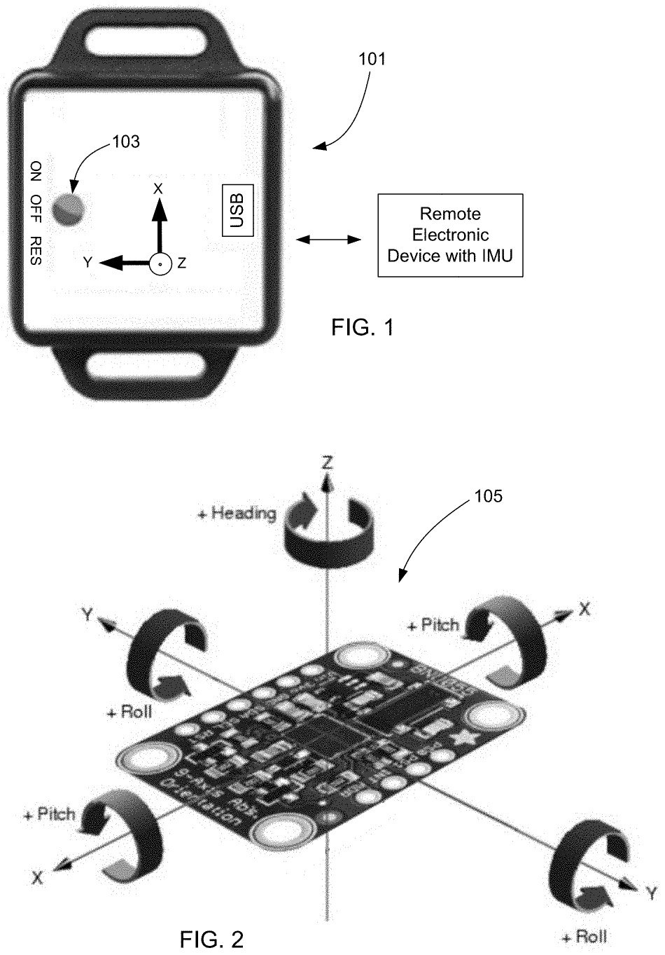

Referring now to FIG. 1 in the drawings, an IMU assembly is illustrated. IMU assembly 101 is provided with a housing and an internal processing board unit 105 (see FIG. 2). Assembly 101 includes an identifier for its central axis and an input device 103 for operating the assembly 101 by turning it off and on and for setting orientation.

The head tracking assembly of the present application is configured to be an IMU device with built-in IMU alignment capability to solve the common problems discussed previously. As noted, an IMU may include an array of sensors used to measure movement and/or orientation. These sensors may include any of the following: accelerometers to measure linear acceleration, gyroscopes to measure rotational rate, and magnetometers to measure magnetic North.

Referring not to FIG. 2 in the drawings, a perspective view of an internal processing board unit 105 in the IMU assembly 101 is shown. Unit 105 provides of the representative degree of freedom of an IMU 101 in a tracking assembly is illustrated. IMU 101 can have various degrees of freedom (DOF) and can be based on the number of measurements it takes. For example, 6 DOF takes 6 measurements such as 3 for the accelerometer (x, y, z axis) and 3 for the gyroscope for rotation about each axis. In a 9 DOF, the IMU may include 3 from a magnetometer for degrees of alignment about the axis with respect to Magnetic North. This allows the ability to sense orientation.

The IMU of the present application may include data fusion which refers to the science of filtering and combining all measurements taken by an IMU to make a single useful output that is well beyond just raw data.

Wherein typically the mathematics is complex for properly aligning the IMU or providing alignment capability to an IMU, the tracking assembly of the present application includes those capabilities. It is understood that the tracking assembly of the present application is described with respect to a head device for a user, but such is not limited to the precise application. The IMU assembly may be associated with other devices or widgets as needed. Various options are available to provide the alignment capability.

The IMU is built with an input device 103 (i.e. a button) and an onboard processor 105 capable of performing the fusion algorithm and offset/alignment conversions. The user is given an option of at least three methods of performing the alignment process. Each of the three methods is a specific implementation of a single more general concept.

As a general concept, the user mounts the IMU on an object of interest in a position that is not necessarily physically aligned with the object of interest. The user places the object of interest into a known “reference orientation” (note: methods of determining the “reference orientation” are what give us the 3 specific alignment methods below). The user triggers the system via input device 103 (i.e. with a button input or wirelessly) to capture the IMU's momentary orientation. Unit 105 calculates the offset between the captured IMU 101 orientation and the reference orientation. The assembly 101 continuously applies the calculated offset to the raw IMU orientation to calculate the orientation of the object of interest.

In a first optional method, the user may mount IMU assembly 101 arbitrarily to the object of interest. The user then places the object of interest in a known, pre-selected orientation (i.e. level with the Earth and facing North). In this case, level with Earth and facing North would be the “reference orientation”. In this optional method, the “reference orientation” is be pre-decided (i.e. hard-coded into the programming). The user presses input device 103 and unit 105 captures the orientation of IMU assembly 101. Assembly 101 then proceeds to calculate the physical offset between IMU assembly 101 and the pre-determined reference position. As movement of the object occurs, assembly 101 begins applying the offset to subsequent frames of data thus reporting the orientation of the object of interest rather than the orientation of the IMU assembly.

In a second optional method, the user holds the IMU assembly 101 and physically aligns it with the object of interest. The user activates the input device 103 to capture it's current orientation. Since the IMU assembly 101 is being held in the same physical orientation as the object of interest at the moment of the triggering, the captured orientation becomes the “reference orientation”. The user mounts IMU assembly 101 arbitrarily to the object of interest and activates the input device 103 a second time so as to calculate the offset between the previously captured orientation and its current orientation. Assembly 101 begins applying the offset to subsequent frames of data, thus reporting the orientation of the object of interest rather than the orientation of the IMU.

In a third optional method, a secondary IMU from a remote electronic device may be used (i.e. the IMU in a smartphone). The user mounts the IMU arbitrarily to the object of interest. The user holds the secondary IMU (i.e. smartphone) in the same orientation as the object of interest and then activates the process of capturing the orientation of the secondary IMU, being on the remote electronic device. This orientation becomes the reference orientation. Activation may be done through input device 103 or through wireless methods via the remote electronic device. Also upon activating, the IMU assembly 101 captures the orientation of the IMU, itself. IMU assembly 101 calculates the offset between the reference orientation and the IMU orientation and begins applying the offset to subsequent frames of data thus reporting the orientation of the object of interest rather than the orientation of the IMU.

It is understood that such solutions are exemplary in nature and that other modifications are known in the art and may be applied without resulting the uniqueness of the IMU assembly. As noted, a great application of the IMU assembly is seen with a headset or head tracking device which can monitor the acceleration, rotation, and orientation of the head about all axis. This can help with tracking line of sight among other functions.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A method or orienting an IMU to an object, comprising:
coupling the IMU to the object;
orienting the object in a pre-selected orientation to determine a reference orientation;
activating an input device to initiate the IMU to process the orientation of the IMU; and
calculating the physical offset between the IMU and the object;
wherein the IMU applies the physical offset to subsequent frames of data reporting on the orientation of the object rather than the orientation of the IMU.

2. A method or orienting an IMU to an object, comprising:
holding the IMU in physical alignment with the object;
activating an input device to initiate the IMU to process the orientation of the IMU, the orientation of the IMU being that of the object to become a referenced orientation;
coupling the IMU to the object in any orientation; and
activating the input device a second time to initiate the IMU to capture the physical offset when coupled to the object;
wherein the IMU applies the physical offset to subsequent frames of data reporting on the orientation of the object rather than the orientation of the IMU.

3. A method or orienting an IMU to an object, comprising:
locating a secondary IMU in a remote electronic device;
coupling the IMU to the object;
locating the secondary IMU in the same orientation as the object;
activating an input device to capture the orientation of the secondary IMU, this orientation becoming a reference orientation of the object; and
capturing the orientation of the IMU upon activation of the input device to determine a physical offset between the orientations of the IMU and the object;
wherein the IMU applies the physical offset to subsequent frames of data reporting on the orientation of the object rather than the orientation of the IMU.
